(19) United States
(12) Patent Application Publication
(10) Pub. No.: US 2009/0029331 A1
(43) Pub. Date: Jan. 29, 2009

(54) Active cutaneous technology

(76) Inventors: Gregory P. Crawford, Barrington, RI (US); Gregory D. Jay, Norfolk, MA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/157,651

(22) Filed: Jun. 12, 2008

Related U.S. Application Data
(60) Provisional application No. 60/943,358, filed on Jun. 12, 2007.

(51) Int. Cl. G09B 23/28

(52) U.S. Cl. 434/262

(57) ABSTRACT

Active cutaneous technology to emulate the cutaneous characteristics of skin in medical training and other applications. Skin color changes are implemented with paint-on, electrically tunable, reflecting material that can conform to a mold, such as a manikin body or consumer product, and will enable the device to simulate skin. For example, skin colors associated with bruises, blue skin or cyanosis, redness from carbon monoxide poisoning or over radiation, and yellow skin from jaundice. Skin texture changes (e.g., goosebumps, rashes, and poxes) are established using tunable topological polymer films that grow in predetermined directions. Hair-raising, or piloerections, are accomplished with polymer-MEMS with varying thermal expansion coefficients on either side of a hair fiber due to anisotropic molecular alignment. These technologies are integrated, addressable and programmable through a control system.

### CROSS-REFERENCE TO RELATED ACTIONS

This application claims priority to U.S. Provisional Application No. 60/943,358, filed on Jun. 12, 2007.

### STATEMENT AS TO FEDERALLY-SPONSORED RESEARCH

This invention was made at least in part with Government support under Grant No. 0506072, awarded by the National Science Foundation. The Government has certain rights in this invention.

### BACKGROUND

Health care educators are under significant pressure and budgetary constraints to enhance the overall quality of medical training. Accordingly, medical educators are placing an increased reliance on simulation technology to strengthen learner knowledge, provide safe and low-risk practice environment, and shape the acquisition of health care professionals' clinical skills. Simulators can be broadly categorized into screen-based programs, task specific training aids, full-size manikin patient simulators, and virtual reality. In particular, current high-fidelity manikin patient simulators offer to enhance the effectiveness of learning in a safe and controlled environment, allowing trainees to gain valuable clinical and procedural experience. Further, the manikin simulators assist trainees improve communication, organization, and multitasking skills without relying on chance encounters with patients in a clinical setting. Generally, while the current high-fidelity manikin simulators allow for basic procedural practice, there is often a lack of situational realism. For example, current simulation manikin skins are manufactured in one skin color and therefore unable to accurately replicate human skin color, appearance, and responses to physiologic and pathophysiologic changes. Static moulage, such as pre-fabricated inserts and strap-secured layers, are required to provide trainees with dermatologic cues. Often, instructor intervention is also required to describe or generate a clinical finding during a simulation scenario. This lack of situational realism can detract from the educational experience. Accordingly, the ability to manipulate certain cutaneous characteristics would add a degree of situational realism to a patient simulator, and therefore enhance the effectiveness of a training session.

### SUMMARY

In general, in an aspect, the invention provides an active skin apparatus including a composite material including cholesteric liquid crystals, an ultraviolet light absorbing dye, and a polymer forming blend, disposed on a compliant polymer substrate, wherein the cholesteric liquid crystals are compartmentalized within the composite material, and the compliant polymer substrate includes more than one electrodes, and an amplitude modulation signal generator coupled to the electrodes and configured to provide at least one voltage to at least one of the electrodes.

Implementations of the invention may include one or more of the following features. A patterned resistive heater can be disposed on the composite material, a reactive mesogen film can be disposed on the patterned resistive heater, such that the mesogen film includes an area of chiral symmetry and an area of isotropic disorder, and a pulse width modulation signal generator can be coupled to the patterned resistive heater and configured to provide a voltage pulse to the heater. The active skin may also include a polymer-MEMS attached to the reactive mesogen film, such that the polymer-MEMS includes a first polymer with a first thermal expansion coefficient and a second polymer with a second thermal expansion coefficient, and can be configured to raise and lower based on the voltage provided by the pulse width modulation signal. The active skin can be configured to conform around a mold.

Also, implementations of the invention may include one or more of the following features. The active skin apparatus can include a control system that can be operably connected to the amplitude modulation signal generator and the pulse width modulation signal generator, such that the control system can include a processor, memory and computer readable instructions, and can be configured to control the output of at least one of the signal generators. The control system can include a training program configured to control the outputs of the signal generators based on input from a user.

In general, in another aspect, the invention provides a medical simulation training system including a control system, a human sized manikin including more than one active skin regions that are integrated into the manikin, such that the active skin regions are coupled to the control system, and a personal computer coupled to the control system, such that the personal computer is configured to store and execute instructions directed to changing the color of at least one of the active skin regions. The active skin regions can include cholesteric liquid crystals and an array of electrodes, such that the electrodes are coupled to the control system.

Also, implementations of the invention may include one or more of the following features. The active skin regions can include a reactive mesogen film disposed on a patterned resistive heater, such that the patterned resistive heater can be coupled to the control system and the personal computer can be configured to store and execute instructions directed to changing the texture of at least one of the active skin regions. The active skin regions can include polymer-MEMS attached to the reactive mesogen film and can be configured to raise and lower based on the signal to the patterned resistive heater from the control system. At least one active skin region can be located in the eye of the manikin. The control system can located within the manikin and the personal computer can communicate with the manikin via a wireless connection. The color of the active skin region can correspond to a medical symptom.

In general, in another aspect, the invention provides a process for producing an active skin based on the formation of phase-separated liquid crystal and polymer layers by the photopolymerization of a thin film coated on a single compliant polymer substrate, the process includes applying a thin film of about 10-25 microns of a composite material including cholesteric liquid crystals, an ultraviolet absorbing dye, and a polymer-forming blend onto the compliant polymer substrate, such that the compliant polymer substrate includes an array of conducting electrodes, shielding the thin film with a mask, exposing the thin film to a first ultraviolet light, such that the mask blocks at least a portion of the thin film from the exposure, removing the mask, and exposing the thin film to a second ultraviolet light.

Implementations of the invention may include one or more of the following features. The exposing the thin film to a first ultraviolet light can occur in a nitrogen atmosphere. The mask can be geometrically configured to be substantially similar to the geometric arrangement of the array of electrodes. The process may also include conforming the compliant substrate and the thin film around a mold, heating the compliant substrate and the thin film to a temperature above the glass transition temperature of the polymer-forming blend, and cooling the compliant substrate and thin film to approximately 20° C.

In general, in another aspect, the invention provides a process of for producing a tunable topological polymer film including disposing a mesogen film including a chiral additive onto a compliant polymer, irradiating the mesogen film with ultraviolet light through a mask, such that the regions of the mesogen film that are exposed to the ultraviolet light undergo photopolymerization, heating the mesogen film to a temperature above the cholesteric-isotropic transition, and irradiating the entire mesogen film to a blanket exposure of ultraviolet light. The compliant polymer includes a patterned Indium Thin Oxide (ITO) resistive heater, and heating the mesogen film includes activating the ITO heater.

In accordance with implementations of the invention, one or more of the following capabilities may be provided. Simulation manikins can integrate materials and medical sciences to emulate the cutaneous characteristics of skin in medical training applications. Skin color changes can be implemented with paint-on, electrically tunable, reflecting material that can conform to a manikin body and will enable the skin to simulate, for example, bruises, blue skin or cyanosis, redness from carbon monoxide poisoning or over radiation, and yellow skin from jaundice. Skin texture changes (e.g., goosebumps, rashes, and poxes) can be established using tunable topological polymer films that grow in predetermined directions. Hair-raising, or piloerections, can be accomplished with polymer-MEMS with varying thermal expansion coefficients on either side of a hair fiber due to ansiotropic molecular alignment. These technologies can be integrated, addressable and programmable through a personal computer.

These and other capabilities of the invention, along with the invention itself, will be more fully understood after a review of the following figures, detailed description, and claims.

### BRIEF DESCRIPTION OF THE FIGURES

The application file contains one drawing executed in color. Copies of this application publication with the color drawing will be provided by the Office upon request and payment of the necessary fee.

FIG. 1 is a diagram with examples of cutaneous responses on a manikin (executed in color).

FIGS. 2A-D is a process to create a paint-on CLC sample.

FIG. 3 is an illustrative diagram of a CLC sample on a compliant substrate.

FIG. 4 is a diagram of a CLC mold.

FIGS. 5A-B is a illustrative diagram of process to create patterned reactive mesogen films.

FIGS. 6A-C is an illustration of the response of a patterned reactive mesogen film to temperature change.

FIG. 7 is a diagram of a p-MEMS hair bundle.

FIG. 8 is a perspective diagram of an active manikin skin.

FIG. 9 is a flow diagram of a process to stimulate an active skin.

### DETAILED DESCRIPTION OF PREFERRED EMBODIMENTS

Embodiments of the invention provide techniques for providing an active manikin skin. Phase-separated Liquid Crystal (LC) and polymer layers are formed by the photopolymerization of a thin film coated on a compliant polymer substrate. The compliant substrate has conducting lines patterned in an in-plane configuration such that when a voltage is applied, an electric field is generated in the plane of the substrate. A masking step creates polymer walls above the conducting lines. Upon application of an electric field, the perceived color of the thin film changes. The change in color emulates symptoms associated with a medical condition. Corresponding skin texture changes are established using tunable topological polymer films that can grow in predetermined directions. Hair-raising (i.e., piloerection) is accomplished with polymer-MEMs with varying thermal expansion coefficients on either side of a “hair-fiber” due to anisotropic molecular alignment. The active manikin skin can be controlled locally and remotely with analog, digital and similar networked controllers This active manikin skin is exemplary, however, and not limiting of the invention as other implementations in accordance with the disclosure are possible.

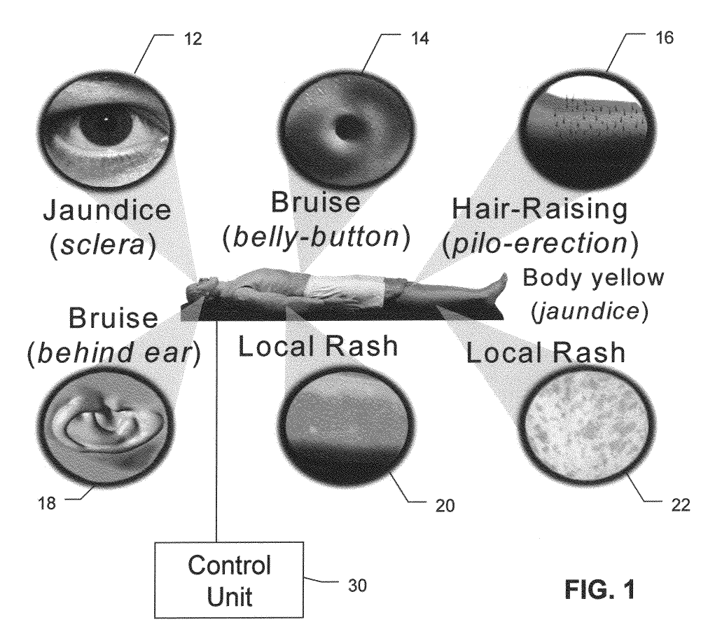

Referring to FIG. 1, a medical simulation manikin 10 with active skin is shown. The manikin 10 is operably connected to a control system 30. In an embodiment, the control system 30 is a personal computer disposed in proximity to the manikin 10. Also, as an example only and not a limitation, the control system 30 is a digital processor disposed inside of the manikin 10 and is configured to receive wireless instructions. The control system 30 can include computer-readable medium such as disk drives, CD and DVD Disks, Flash memory and other nonvolatile memory. The manikin 10 includes examples of various cutaneous responses such as jaundice 12, bruises 14, 18, hair-raising 16, and local rashes 20, 22. As will be discussed, the manikin 10 includes paintable (e.g., paint-on) liquid crystal and polymer dispersion technology and ordered polymer materials (i.e., reactive mesogens) to create a layer of materials that can be electrically modified from blue to red, or any desired color in between, and a layer that can be addressed to create a texture on the surface of the manikin. In general, each of the symptoms on the manikin 10 are addressable and selectable. For example, each symptom could be turned on or turned off at the discretion of a trainer, or training program operating on a computer, based on the treatment provided by a trainee. The control system may include voice recognition software configured to process questions posed by the trainee, and speech generation software to provide audible patient explanations and exclamations based on the trainee's questions. The location of the symptoms 12,14,16,18,20,22 are exemplary only (i.e., the active skin could be disposed on other surfaces of the manikin 10). The general implementation approach for the manikin 10 includes creating a variety of new symptoms and responses in a medical simulation theater (e.g., training curriculum) and therefore introduce a plurality of new symptoms and situations for training purposes.

As examples only, and not as limitations, the manikin 10 is capable of demonstrating the following symptoms and thus provide the associated training experience for a trainee:

Jaundice 12 is a symptom that can occur in many different diseases. Jaundice is the yellowish staining of the skin and sclera (whites of the eyes) that is caused by high blood levels of bilirubin. There are several possible causes of jaundice: liver ailments; inflammation or blockage of bile ducts; drugs; certain genetic disorders; jaundice of pregnancy (e.g., choestasis, pre-eclapsia, acute fatty liver).

Methemonglobin is a particular type of hemoglobin that is altered so that it is useless for carrying oxygen and delivering it to tissues throughout the body. Since hemoglobin is the key carrier of oxygen in the blood, its wholesale replacement by methemonglobin can cause cyanosis (a slate gray-blueness) due to lack of oxygen. Presence of methemonglobin in the blood is termed Methemonglobinemia. There are several causes of Methemonglobinemia: exposure to a number of different chemical agents, or it may be congenital HbM disease, or a deficiency of the enzyme methemonglobin reductase, required for reduction of methemoglobin to normal oxyhemoglobin.

Carbon monoxide, a byproduct of combustion, acts as a poison by competing with oxygen for binding sites on hemoglobin. At higher concentrations of carbon monoxide in the blood, signs of poisoning can include cherry reddish skin. Causes of carbon monoxide poisoning can be self-inflicted (i.e., attempted suicide) or accidental (e.g., exhaust from car, furnace, houseboats).

Cyanosis is the condition of children turning a bluish color, sometimes referred to as blue baby. Children with heart disease are blue because compared to other children, a lower amount of oxygen is carried in the blood going to the body. This is known as blue or cyanotic disease. Children can be cyanic for many reasons: heart disease; lung or breathing problems; cold; or as a consequence of seizures. Cyanosis can be present all the time with certain unrepaired heart problems such as transposition of the great arteries, hypoplastic left heart syndrome, or Tetralogy of Fallot.

A bruise or contusion 14, 18 is caused when tiny blood vessels are damaged or broken. A purpleish, flat bruise that occurs when blood leaks out into the top layers of skin is referred to as a ecchymosis. When it first appears, a bruise will be reddish looking, reflecting the color of the blood in the skin. By one or two days, the reddish iron from the blood undergoes a change in the bruise will appear blue or purple. By day six, the color changes to green, and at day 8-9, the bruise will appear yellowish brown. The causes of bruises are many fold such as injury, or abuse. Local bruising is a symptom of more serious conditions: petechiad refers to a small accumulation of blood beneath the skin indicating serious health problems (e.g., endocarditis, abnormal blood clotting); local bruises around the belly button indicates abdominal bleeding; bruising behind the ear (battle sign) indicates a skull fracture; raised bruises that occur without injury can be a sign of autoimmune diseases.

A rash 20, 22 means a localized reddish discoloration of the skin, usually associated with an outbreak of red bumps on the body. The rash of chickenpox develops in crops with raised red spots addressing the blisters that burst before crossing over. Shingles starts a small blisters on a red base following the path of individuals nerves from the spinal cord. Hives (urticaria) and welts are red and raised areas of varying sizes and shapes. There are many causes of rashes. Examples include allergic reactions, chemical irritation, hives, shingles, lichen planus, measles, ringworm, chickenpox, smallpox, poison ivy, etc.

Arrectoris pilorum are tiny muscles that act as the hair erector muscles. They play key role in goose bumps (i.e., cutis anserine), a temporary local change in the skin. Starting with a stimulus such as colder fear causing nerve discharge from the sympathetic nervous system. The nerve discharge causes contraction of the arrectores pilorum, elevating the hair follicles (i.e., piloerection 16). Goose bumps are usually a result of stimulus such as cold or fear. Piloerection is also a rare symptom of some diseases, such as temporal lobe epilepsy, some brain tumors, and autonomic hyperreflexia.

These textures and colors are exemplary only and not a limitation. The active skin can be configured to mimic colors and textures beyond medical examples. For example, the active skin can be integrated with consumer products to provide a wide range of colors (e.g., green, orange, blue), as well as texture.

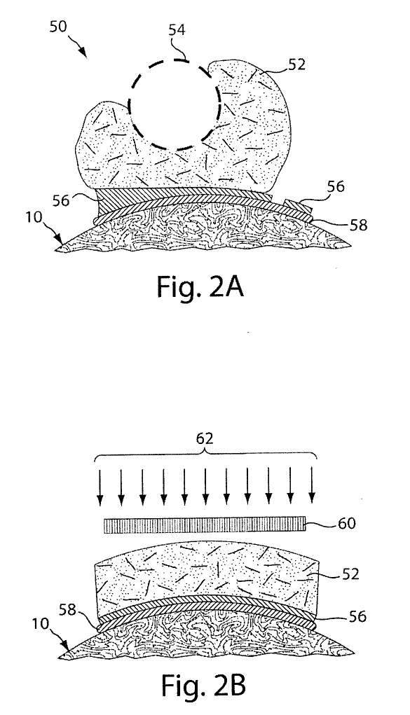

Referring to FIGS. 2A-B, a process 50 to create a paint-on Cholesteric Liquid Crystal (CLC) is shown. The process includes a composite material consisting of cholesteric liquid crystals, a dye, and a polymer-forming blend 52 (e.g., acrylate family), a Meyer Bar 54, conducting electrodes 56, a compliant substrate 58, at least one mask 60, and ultra-violet (UV) light 62. The paint-on CLC is based on the formation of phase-separated liquid crystal and polymer layers by the photopolymerization of a thin film (e.g., 10-25 microns) coated on a single compliant polymer substrate. For example, a film-form technique (e.g., with the Meyer bar 54, or knife blade) is utilized to apply a thin “wet’ film of about 10-25 microns of the composite material 52 onto a compliant polymer substrate 58 (e.g., polyester). The complaint substrate 58 includes, or is attached to, a plurality of conducting electrodes 56 (e.g., indium tin oxide (ITO)) patterned in an in-plane configuration such that an electric field is generated in the plane of the substrate when a voltage is applied to the electrodes 56. The complaint substrate 58 and the electrode 56 are comprised of translucent or transparent material. In FIG. 2B, the thin-film 52 is initially masked off 60 and subsequently exposed to ultraviolet light 62. Based on the composition of the thin-film 52, the exposure may occur in a nitrogen atmosphere. The mask 60 and ultraviolet light 62 creates polymer walls 53 above the electrodes 56. In FIG. 2C, the mask 60 is removed and a second ultraviolet exposure 62 is performed. The presence of a dye which absorbs ultraviolet radiation in the composite material 52 induces an ultraviolet intensity gradient across the thickness of the thin-film 52. As a result, the photopolymerization predominately occurs where the ultraviolet intensity is the highest (i.e., near the film surface 66 that is directed towards the ultraviolet source). In FIG. 2D, the final film 52 results in a CLC structure compartmentalized in a polymer supporting infrastructure.

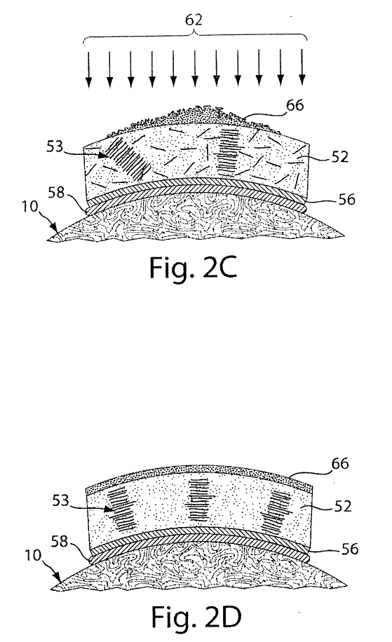

Referring to FIGS. 3A-B, the operation of the in-plane driven CLC configuration 52 is shown. Standard room lighting 70, 72 is shown upon the CLC 52 and is reflected 74. The chiral material reflects incoming light 72 of a particular wavelength bandwidth. In one example, the CLC mixture 52 is tuned to reflect at approximately 350 nm such that the CLC mixture 52 is approximately invisible. In FIG. 3A, the voltage 76 applied to the electrodes 56 is zero, and an observer viewing the reflection 74 observes the underlying color of the substrate 73 (e.g., normal skin color). In operation, as the voltage 76 to the electrodes 56 increases, the pitch of the CLC lengthens and that the color of the reflection 74 red shifts. For example, in FIG. 3B the electric field 80 increases to a value E1 in the reflection 82 is blue (i.e., cyanic). The value of the electric field 80 can be further adjusted to reflect a plurality of colors in the visible spectrum (e.g., jaundice yellow, rash red, bruise purple). Additionally, the underlying color of the substrate 73 can be black and the CLC mixture 52 can be tuned to an approximate skin color. The surface of the CLC 66 can be textured to make the reflection 74, 82 more diffuse and thus approximately match the chromaticity coordinates of skin.

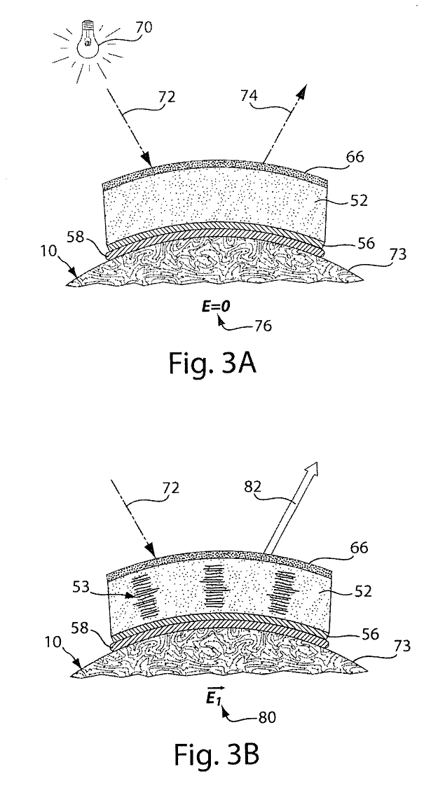

Referring to FIG. 4, with further reference to FIGS. 2 and 3, an example of a CLC mold 100 is shown. A thin-film CLC 52, including the substrate 58 and electrode 56 can be conformed around a mold (i.e., the mannequin 10). For example, a CLC sample 102 is conformed around the forearm and elbow 104 of the mannequin 10. Once the CLC sample 102 is conformed around an object (i.e., the form 102), it is heated to a temperature above the glass transition temperature of the polymer (e.g., Tg for polyester is approximately between 90-120° C.), and then allowed to cool back to room temperature. In practice, special attention must be given to the electrode 56 (e.g., comprised of ITO) because they may crack when stressed. For example, if the total film thickness 52 is on the order of 200 μm, and the radius of the human form is approximately 60 mm, the strain on the electrodes 52 is approximately 0.33%. The critical strain where an ITO electrode 52 begins to crack is approximately 2%. Accordingly, current ITO electrodes are suitable for use on the gentle sloping curves of the human body. Nonetheless, advances in thin-film technologies, such as a highly malleable indium conductor which is capable of enduring higher stresses and strains, can be incorporated into the molding process 100.

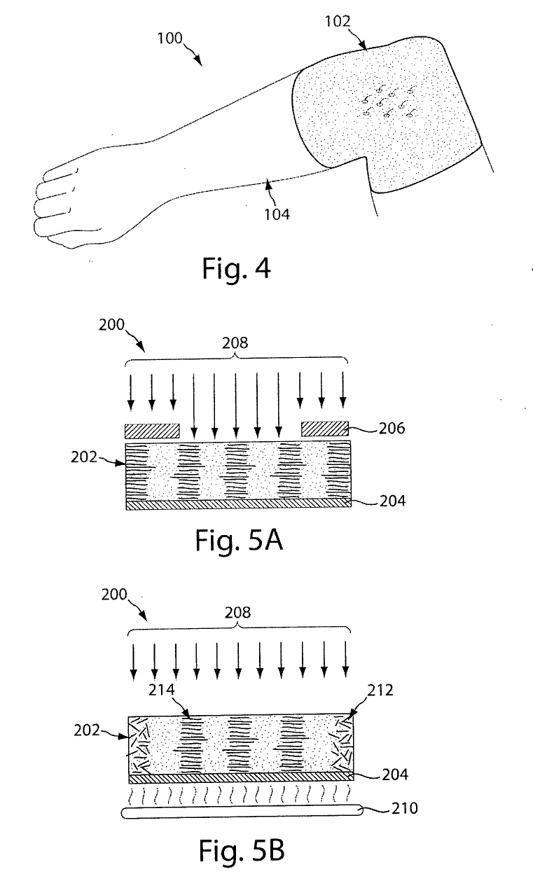

Referring to FIGS. 5A-B, a process 200 for creating a tunable topological polymer film (e.g., skin topological features) is shown. The process includes a mesogen film with a chiral additive 202, a compliant material 204, a chrome mask with circular apertures 206, and ultraviolet light source 208, and a heater element 210. The basis for tunable topological polymer films is a patterned reactive mesogen film comprised of liquid crystal phases in a low molar mass form. When the mesogen film is exposed to ultraviolet light, polymerization occurs which captures the liquid crystalline order indefinitely. A mesogen film with a chiral additive 202 is disposed on compliant material 204 and a cooled to room temperature forming a chiral liquid crystal phase. The chrome mask 206 is disposed over the sample 202. The mesogen sample 202 is then irradiated with ultraviolet light 208 to initiate photopolymerization. Only the regions that experience the UV light 208 through the mask 206 capture the chiral symmetry through photopolymerization, while the other regions remain in their low molar mass form. In FIG. 5B, the mask 206 and the mesogen sample 202 is then heated (e.g., via a resistive ITO heater 210) to a temperature above the cholesteric-isotropic transition (T>T_{NI}) (e.g., 80°-120° C. based on materials used). The sample 202 is then irradiated with a blanket UV exposure 208 to lock the remaining isotropic disorder. As a result, the mesogen sample 202 is a patterned array of isotropic regions 212 and chiral regions 214.

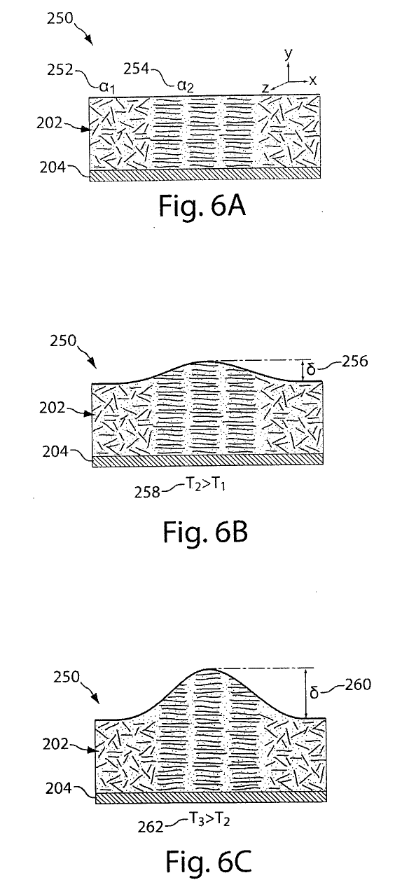

Referring to FIGS. 6A-C, with further reference to FIGS. 5A-B, a process 250 for creating a surface topology (e.g., goose bumps) is shown. The process includes a mesogen sample 202, a compliant substrate 204, a heater 210 (shown in FIG. 5B), an isotropic region base height 252, and a chiral region base height 254. The mesogen sample 202 is heated with the resistive ITO heater 210. The thermal excitation creates a thermal expansion mismatch between the helical regions (i.e., chrial regions 214) and the isotropically disordered regions (i.e., isotropic regions 212). As a result, the chiral regions 214 will rise higher than the isotropic regions 212. The height differential 256 can be measured in micrometers when the temperature differential 258, 262 is approximately 90° C. The process is reversible (i.e., the height differential 256 can be reduced) if the current to the heater 210 is reduced.

In operation, a mesogen sample 202 is integrated, or similarly attached, to the mannequin 10. The height differentials 256 are on the order of 10-100 μm or larger. Further, short pitch samples within the mesogen material 202 allow for an approximately transparent result, and various masks 206 enable the implementation of various topological features including irregular shapes and dimensions to mimic the irregular features on the human body.

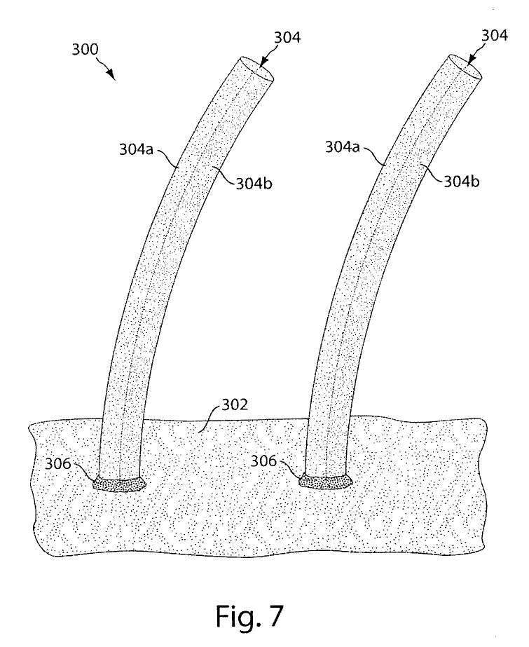

Referring to FIG. 7, a system 300 for enabling piloerections (i.e., hair raising) is shown. The system includes a top substrate 302, at least one p-MEM hair 304 including a first side 304a and a second side 304b, and mounting adhesive 306. In general, the p-MEM hairs 304 are polymers which are formed into fiber threads using a capillary tube, wherein the capillary tube is removed after polymerization. The diameter of the threads (i.e., p-MEM hairs) is approximately 50-100 microns (μm). The polymer on first side of the fiber 304a has a different coefficient of thermal expansion (i.e., density) than the polymer on the second side of the fiber 304b. In operation, heat is applied to the p-MEM hair 304 which causes the fiber to curl as one side 304a expands more than the other side 304b. In an embodiment, the p-MEM hairs 304 are constructed on a planar surface and then sliced into strips, with each strip the approximate width of a human hair (e.g., 50-100 μm). The p-MEM hairs 304 are secured to the surface of the top layer 302 with an adhesive 306. In an embodiment, the hairs 304 extend through the top layer 302 and are secured on a lower layer. As an example, and not a limitation, the p-MEM hairs 304 are manufactured in batches such that a plurality of hairs 304 are integrated with (or otherwise coupled to) a base, and the base is attached to the top layer 302.

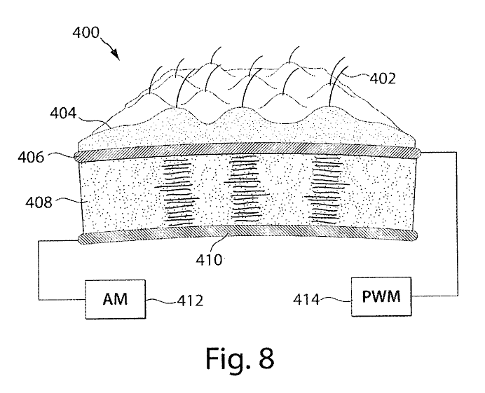

Referring to FIG. 8, a perspective view of active skin 400 is shown. The active skin 400 includes a plurality of p-MEMS hairs 402, a transparent layer of reactive mesogen 404, a patterned resistive heater layer 406, a layer including a plurality of compartmental Cholesteric Liquid Crystals (CLC) 408, a compliant substrate with electrodes 410, an Amplitude Modulation (AM) driver 412, and a Pulse Width Modulation (PWM) driver 414. The CLC layer 408 is integrated on, or otherwise attached to, a polyester substrate with in-plane switching electrodes 410. The substrate 410 is operably connected to the AM driver 412. The patterned resistive heater 406 (e.g., ITO resistive heater) is deposited on the top polymer layer of the CLC 408. The transparent reactive mesogen film 404 will be integrated, or otherwise disposed on, the resistive heater 406. The p-MEMS hairs 402 are secured on top of the reactive mesogen film 404. The hairs 402 are attached individually or in batches. The resistive heater 406 is operably connected to the PWM driver 414. The AM driver 412 and the PWM driver 414 are configured to receive instructions from the control system 30.

In operation, amplitude modulated signals generated by the AM driver 412 are received by the electrodes in the compliant substrate 410. The CLC layer 408 will reflect colors based on the received AM signal. The CLC materials in the layer 408 are driven with AC drive circuitry to reduce the migration and build up of ionic impurities. The reactive mesogen layer 404 will create bumps and texture based on the temperature of the resistive heater layer 406. The resistive heater layer 406 is driven by short pulses or pulse width modulation (PWM) signals received from the PWM driver 414. For example, since the turn on response of the texture films 404 is fast (e.g., 100 ms) and the turnoff is slow (i.e., several seconds), the resistive heater 406 need only be addressed for 100 ms separated by a 5-10 second delay. This long delay keeps the temperature of the CLC layer 408 below the transition temperature (i.e., approximately 90° C.). Also, since the resistive heater 406 is less than 10 μm away from a CLC, separated by a dielectric polymer layer and only on for short pulse durations, it does not interfere with the CLC alignment in the CLC layer 408. The heat from the patterned resistive heater 406 will also result in a piloerection (i.e., hair-raising) since the temperatures of the texture bulging and piloerection are comparable. In an embodiment, a temperature sensor is disposed in proximity to the ITO heater 406 and is configured to provide feedback to the PWM driver 414. Accordingly, the PWM driver is capable of operating with known closed-loop control algorithms (e.g., PI, PID).

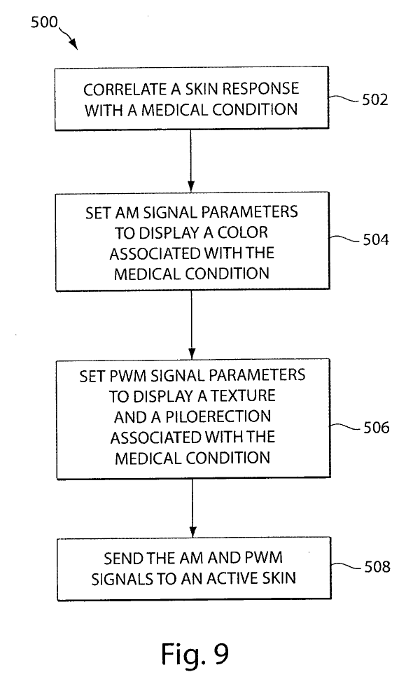

In operation, referring to FIG. 9, with further reference to FIG. 8, a process 500 for using the system 400 includes the stages shown. The process 500, however, is exemplary only and not limiting. The process 500 may be altered, e.g., by having stages added, removed, or rearranged.

At stage 502, a correlation between a skin response and a medical condition is determined. For example, as discussed above, reddish skin can indicate a rash while yellowing might indicate jaundice. The active skin 400 can accommodate a wide spectrum of visible light and texture responses. Accordingly, in addition to the symptoms discussed in regards to FIG. 1, correlations with less familiar conditions, such as those presented by bioterrorism toxins, can also be determined. For example, cutaneous anthrax produces pruritic papule. Such spectral and tactile data can be incorporated into a training regime to improve awareness amongst first responders and medical professionals.

At stage 504, the AM signal parameters associated with the skin color determined in stage 502 are set. The CLC layer 408 will respond to an amplitude modulated (AM) signal sent from the AM signal driver 412 to the electrodes 56 in the compliant layer 410. The signal driver 412 can receive the AM signal parameters manually (e.g., from a local user interface), or remotely (e.g., from a control system 30). The AM signal parameters can be temporally based such that the color of the active skin can change with time over an extended training session.

At stage 506, the PWM signal parameters associated with the skin texture determined at stage 502 are set. The mesogen film 404 responds to the temperature changes in the ITO heater 406, which are caused by the PWM signals sent from the PWM driver 414. The PWM signal parameters can be set locally or remotely, and include a temporal component as discussed in regards to the AM parameters.

At stage 508, a AM signal and a PWM signal are sent to the active skin 400. The signals are based on the parameters set at stages 504, 506 respectively. In general, the AM driver 412 and PWM driver 414 provide simultaneous signals to the active skin 400 to achieve the desired skin response. However, the drivers 412, 414 can operate independently. Further, a single driver 412, 414, can be configured to provide multiple signals to multiple areas of active skin on the manikin 10.

A manikin 10 including an area of active skin 400 can be further configured to produce gaseous perspiration (e.g., see “Measurement of clothing thermal insulation and moisture vapour resistance using a novel perspiring fabric thermal manikin,” J. Fan and Y. S. Chen, Meas. Sci. Technol. 13 (2002) 1115-1123). The area and rate of perspiration can be configured to emulate medical conditions which occur simultaneously with the skin color and texture symptoms described above.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations. Signals can be transmitted and received over physical and wireless connections. The active skin 400 is not limited to medical manikins. For example, the active skin can be incorporated on social robots (e.g., Kismet of MIT) to enhance a user's perception of a robot's emotional program (i.e., a shy robot may blush; an angry robot dog may raise the hair on its neck). Further, active skin is not limited to replication of biological entities such as humans and dogs. For example, molds of personal media players (e.g., Blackberry®, iPod®) can be used to create an active skin configured to change colors and exhibit goose bumps when, for example, a particular song is selected, a particular email is received, or other system status point is realized. Similarly, personal computers (e.g., laptops) and peripherals (e.g., pointing devices, monitor) can include an active skin configured to change color and texture in response to system and program conditions (i.e., an error condition, low battery warning, receipt of an email from a special address). Cell phone covers and telephone handle receivers can be clad, or otherwise attached, to an active skin and configured to change color and texture in response to an incoming call, or other system condition (i.e., low power, low subscriber minutes, text and voice message status). The color and tactile response incorporated in the active skin provides a user additional sensory input regarding the status of a device, or the information therein.

Further, while the description above refers to the invention, the description may include more than one invention.

What is claimed is:

1. An active skin apparatus comprising:
a composite material including cholesteric liquid crystals, an ultraviolet light absorbing dye, and a polymer forming blend, disposed on a compliant polymer substrate, wherein the cholesteric liquid crystals are compartmentalized within the composite material, and the compliant polymer substrate includes a plurality of electrodes; and
an amplitude modulation signal generator coupled to the plurality of electrodes and configured to provide at least one voltage to at least one of the electrodes.

2. The active skin apparatus of claim 1 further comprising:
a patterned resistive heater disposed on the composite material;
a reactive mesogen film disposed on the patterned resistive heater, wherein the mesogen film includes an area of chiral symmetry and an area of isotropic disorder; and
a pulse width modulation signal generator coupled to the patterned resistive heater and configured to provide a voltage pulse to the heater.

3. The active skin apparatus of claim 2 further comprising a polymer-MEMS attached to the reactive mesogen film, wherein the polymer-MEMS is comprised of a first polymer with a first thermal expansion coefficient and a second polymer with a second thermal expansion coefficient, and configured to raise and lower based on the voltage provided by the pulse width modulation signal.

4. The active skin apparatus of claim 3 further configured to conform around a mold.

5. The active skin apparatus of claim 2 further comprising a control system that is operably connected to the amplitude modulation signal generator and the pulse width modulation signal generator, wherein the control system comprises a processor, memory and computer readable instructions, and is configured to control the output of at least one of the signal generators.

6. The active skin apparatus of claim 5 wherein the control system further comprises a training program configured to control the outputs of the signal generators based on input from a user.

7. A medical simulation training system comprising:
a control system;
a human sized manikin including a plurality of active skin regions that are integrated into the manikin, wherein the active skin regions are coupled to the control system; and
a personal computer coupled to the control system, wherein the personal computer is configured to store and execute instructions directed to changing the color of at least one of the active skin regions.

8. The medical simulation training system of claim 7 wherein the active skin regions are comprised of cholesteric liquid crystals and a plurality of electrodes, wherein the electrodes are coupled to the control system.

9. The medical simulation training system of claim 7 wherein the active skin regions are comprised of a reactive mesogen film disposed on a patterned resistive heater, wherein the patterned resistive heater is coupled to the control system and the personal computer is configured to store and execute instructions directed to changing the texture of at least one of the active skin regions.

10. The medical simulation training system of claim 9 wherein the active skin regions are further comprised of polymer-MEMS attached to the reactive mesogen film and configured to raise and lower based on the signal to the patterned resistive heater from the control system.

11. The medical simulation training system of claim 7 wherein at least one active skin region is located in the eye of the manikin.

12. The medical simulation training system of claim 7 wherein the control system is disposed within the manikin and the personal computer is coupled to the manikin via a wireless connection.

13. The medical simulation training system of claim 7 wherein the color of the active skin region corresponds to a medical symptom.

14. A process for producing an active skin based on the formation of phase-separated liquid crystal and polymer layers by the photopolymerization of a thin film coated on a single compliant polymer substrate, the process comprising:
applying a thin film of about 10-25 microns of a composite material including cholesteric liquid crystals, an ultraviolet absorbing dye, and a polymer-forming blend onto the compliant polymer substrate, wherein the compliant polymer substrate includes a plurality of conducting electrodes;
shielding the thin film with a mask;
exposing the thin film to a first ultraviolet light, wherein the mask blocks at least a portion of the thin film from the exposure;
removing the mask; and
exposing the thin film to a second ultraviolet light.

15. The process of claim 14 wherein the exposing the thin film to a first ultraviolet light occurs in a nitrogen atmosphere.

16. The process of claim 14 wherein the mask is geometrically configured to be substantially similar to the geometric arrangement of the plurality of electrodes.

17. The process of claim 14 further comprising:
conforming the compliant substrate and the thin film around a mold;
heating the compliant substrate and the thin film to a temperature above the glass transition temperature of the polymer-forming blend; and
cooling the compliant substrate and thin film to approximately 20° C.

18. A process of for producing a tunable topological polymer film, the process comprising:
disposing a mesogen film including a chiral additive onto a compliant polymer;
irradiating the mesogen film with ultraviolet light through a mask, wherein the regions of the mesogen film that are exposed to the ultraviolet light undergo photopolymerization;
heating the mesogen film to a temperature above the cholesteric-isotropic transition; and
irradiating the entire mesogen film to a blanket exposure of ultraviolet light.

19. The process of claim 18 wherein the compliant polymer includes a patterned Indium Thin Oxide (ITO) resistive heater, and heating the mesogen film includes activating the ITO heater.
